(19) United States
(12) Patent Application Publication
(10) Pub. No.: US 2004/0120640 A1
(43) Pub. Date: Jun. 24, 2004

(54) Optical filter and optical amplifier using the same

(76) Inventors: Hitoshi Hatayama, Kanagawa (JP); Motoki Kakui, Kanagawa (JP); Tatsuhiko Shitomi, Kanagawa (JP); Masayuki Shigematsu, Kanagawa (JP)

Correspondence Address: MCDERMOTT, WILL & EMERY, 600 13th Street, N.W., Washington, DC, 20005-3096, US

(21) Appl. No.: 10/655,611

(22) Filed: Sep. 5, 2003

(30) Foreign Application Priority Data
Sep. 6, 2002 (JP) 2002-262089

(51) Int. Cl. G02B 6/26

(52) U.S. Cl. 385/27

(57) ABSTRACT

An optical filter with improved ability to control a loss spectrum and an optical amplifier using the same are provided. The optical filter includes a first optical element with a first loss spectrum and a second optical element with a second loss spectrum which are connected together in series between an input port and an output port. The optical filter provides a predetermined loss to input light. A loss control unit controls the overall loss spectrum by shifting the first and second loss spectra in the same direction with respect to wavelength or by shifting only one of the loss spectra.

### BACKGROUND OF THE INVENTION

1. Field of the Invention

The present invention relates to an optical filter for providing a predetermined loss to input light, and an optical amplifier using the same.

2. Description of the Related Art

Optical amplifiers amplify an optical signal transmitted through an optical transmission line without converting the signal into an electrical signal. One known type of optical amplifier is a rare-earth doped fiber amplifier in which an optical fiber doped with a rare earth element, such as erbium (Er), is used as an optical waveguide for amplification.

Recently, Wavelength Division Multiplexing (WDM) transmission systems have been developed and utilized. The WDM transmission system transmits WDM signal light consisting of a plurality of signal components with different wavelengths through an optical transmission line. In the application of an optical amplifier to a WDM transmission system, it is important to amplify all of signal components with equal gain and to output the power of each signal component as a value within a predetermined range. To this end, an optical filter is arranged in the optical amplifier to flatten the gain spectrum of the optical amplifier.

An example of an optical filter is disclosed in PCT International Publication No. WO 01/05005 (Literature 1). This optical filter described in Literature 1 has two Mach-Zehnder Interferometer (MZI) optical circuits that are connected in series. In each of the MZI optical circuits, a temperature adjuster for controlling the loss spectrum is arranged in one of two optical waveguides that are optically coupled to each other via two optical couplers.

In the optical filter described in Literature 1, the temperature of the optical waveguides in the respective optical circuits is adjusted and the loss spectra are shifted in the opposite direction by an equal extent of wavelength. As a result, loss at a predetermined wavelength of the overall loss spectrum of the optical filter is maintained substantially constant, and the gradient of a line approximating the loss spectrum (loss gradient) is controlled to change.

In the case of an Erbium-Doped Fiber Amplifier (EDFA), a variation in the gain spectrum due to a change in the power of signal light is, in many cases, such that the gain gradient changes, whereas the gain in a predetermined wavelength is substantially constant. Therefore, a variation in the gradient of a line approximating the gain spectrum (gain gradient) can be compensated by using this optical filter so as to flatten the gain spectrum.

In this optical filter the control of the overall loss spectrum is limited to the adjustment of the loss gradient in the state where the loss at the predetermined wavelength is maintained substantially constant. Depending on the variation in the gain spectra of the optical waveguides for optical amplification, the gain of the optical amplifier may not be sufficiently flattened.

### SUMMARY OF THE INVENTION

Accordingly, it is an object of the present invention to provide an optical filter with improved ability to control a loss spectrum and an optical amplifier using the same.

In order to achieve the object, a novel optical filter is provided. In one aspect of the present invention the optical filter includes a first optical element with a first loss spectrum; a second optical element with a second loss spectrum, which is connected in series to the first optical element; and a control unit for controlling the overall loss spectrum by shifting the first loss spectrum and the second loss spectrum in the same direction with respect to wavelength.

According to another aspect of the present invention, the optical filter includes a first optical element with a first loss spectrum; a second optical element with a second loss spectrum, which is connected in series to the first optical element; and a control unit for controlling the overall loss spectrum by shifting the first loss spectrum and the second loss spectrum by a different amount in terms of absolute values with respect to wavelength.

An optical amplifier according to an aspect of the present invention includes an amplifying optical waveguide for amplifying signal light by pump light; a pump light supplying unit for supplying the pump light to the amplifying optical waveguide; and an optical filter of the present invention, which is connected in series to the amplifying optical waveguide.

Advantages of the present invention will become readily apparent from the following detailed description, which is simply an exemplary illustration of the best mode for carrying out the invention. The invention is capable of other and different embodiments, the details of which are capable of modifications in various obvious respects, all without departing from the invention. Accordingly, the drawing and description are illustrative in nature, not restrictive.

### BRIEF DESCRIPTION OF THE DRAWINGS

The present invention is illustrated by way of example, and not by way of limitation, in the figures of the accompanying drawing and in which like reference numerals refer to similar elements and in which:

FIG. 1 is a block diagram of an optical filter according to a embodiment of the present invention;

FIG. 2 is a detailed schematic diagram according to the embodiment of the present invention;

FIG. 3 shows, with respect to the optical filter of the embodiment, the optical length L of each optical waveguide, power P supplied to each temperature adjuster, and variation ΔP in the supplied power.

FIG. 4 is a graph showing examples of the loss spectrum of the optical filter of the embodiment;

FIG. 5 is a schematic diagram showing a modification of the optical filter of the present invention;

FIG. 6 is a graph showing other examples of the loss spectrum of the optical filter of the embodiment;

FIG. 7 is a graph showing other examples of the loss spectrum of the optical filter of the embodiment;

FIG. 8 is a block diagram of an optical amplifier, according to an embodiment of the present invention, including the optical filter of the present invention;

FIG. 9 is a graph showing examples of the loss spectrum of the optical amplifier shown in FIG. 8; and

FIG. 10 is a schematic diagram of a Fabry-Perot etalon.

### DESCRIPTION OF THE PREFERRED EMBODIMENTS

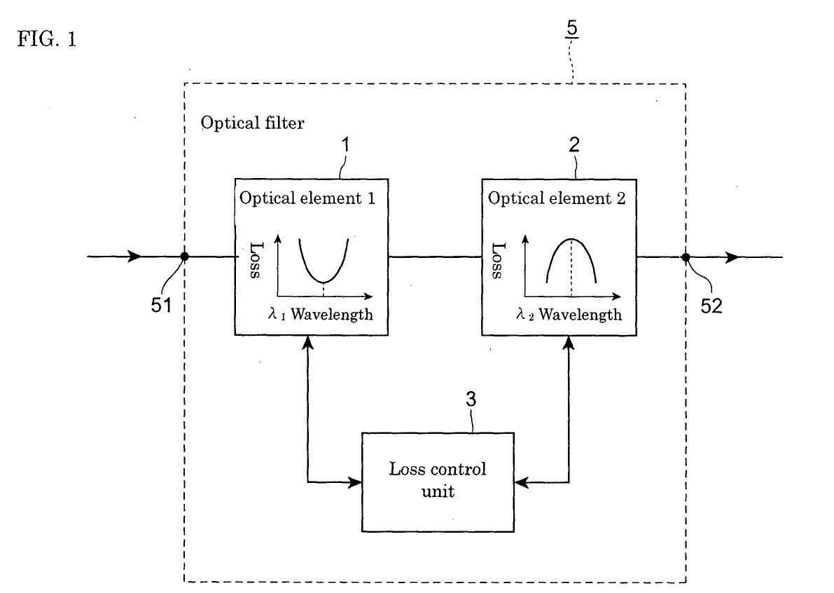

A description of the basic configuration of an optical filter according to the present invention is given here. FIG. 1 is a block diagram of an optical filter 5 of the present invention, which has optical waveguides, such as optical fibers or planar optical waveguides. The optical filter 5 is an optical component for providing a predetermined loss to input light. In particular, the optical filter 5 is suitable for use in compensating a power gradient of WDM signal light.

The optical filter 5 includes a first optical element (optical element 1) and a second optical element (optical element 2). Optical element 1 and optical element 2 are connected in series in the enumerated order in the transmission direction (the direction indicated by the arrow in FIG. 1) between an input port 51 and an output port 52 of the optical filter 5.

The optical elements 1 and 2 have a first loss spectrum and a second loss spectrum, respectively, which are in the form of a sinusoidal wave with respect to wavelength. The first loss spectrum has a minimum loss at a wavelength λ₁. The second loss spectrum has a maximum loss at a wavelength λ₂. A loss control unit (i.e., loss control circuit) 3 is provided to control the overall loss spectrum of the optical filter 5. The loss control unit 3 controls the loss spectrum by shifting the first loss spectrum and the second loss spectrum in the same direction with respect to wavelength or by shifting the first loss spectrum and the second loss spectrum by different absolute values with respect to wavelength.

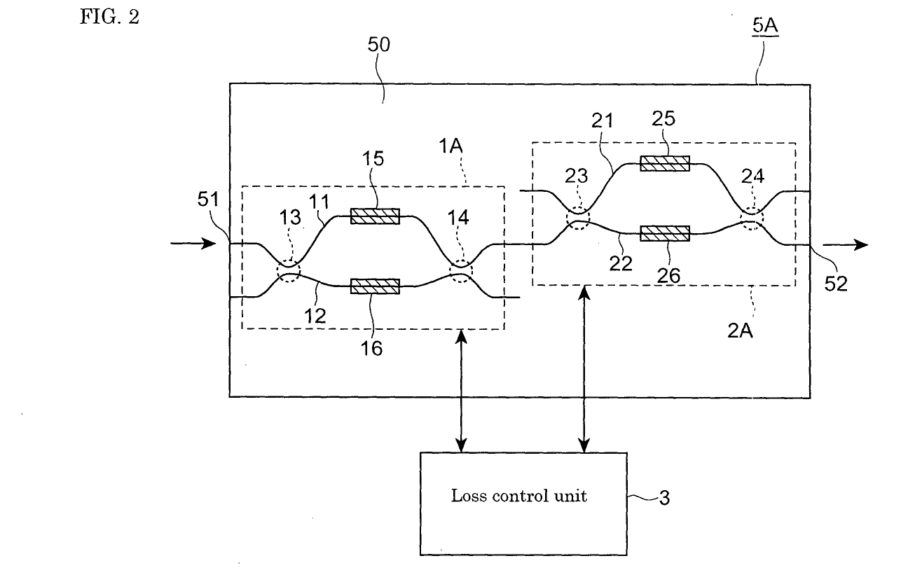

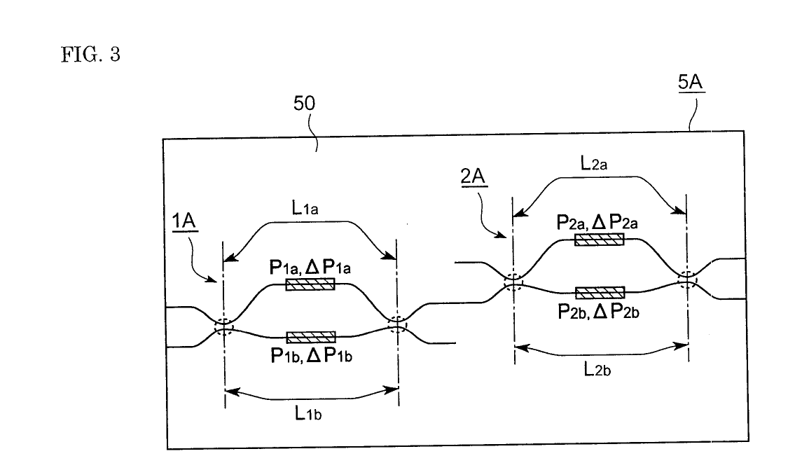

FIG. 2 is a detailed schematic diagram showing an optical filter 5A according to the embodiment of the present invention. FIG. 3 shows the optical filter 5A, in which L is the optical length of each optical waveguide, P is power supplied to each temperature adjuster, and ΔP is a variation in the supplied power P.

The optical filter 5A of the embodiment is a planar waveguide optical circuit including optical waveguides on a substrate 50. On the substrate 50, a first optical element (optical circuit 1A) with a first loss spectrum and a second optical element (optical circuit 2A) with a second loss spectrum are arranged in the named order between the input port 51 and the output port 52.

The optical circuit 1A includes a first optical waveguide (optical waveguide 11) with the optical length L₁ₐ and a second optical waveguide (optical waveguide 12) with the optical length L_{1b}, which is shorter than the optical length L₁ₐ. An end of the optical waveguide 11 (FIG. 2, left) serves as the input port 51 of the optical filter 5A. The optical waveguide 11 is provided with an optical coupler 13 and an optical coupler 14 in the named order in the direction from the input port 51 to the optical circuit 2A. The optical waveguide 12 is optically coupled to the optical waveguide 11 via the optical couplers 13 and 14. The optical waveguides 11 and 12 and the optical couplers 13 and 14 constitute the asymmetrical MZI optical circuit 1A.

Heaters 15 and 16 are provided for the optical waveguides 11 and 12, respectively, so as to control the first loss spectrum in a variable manner. The heaters 15 and 16 are used for adjusting the amount of phase-retardation with respect to light transmitted through the optical waveguides 11 and 12, respectively, by adjusting the temperature of the optical waveguides 11 and 12. The temperature of the heaters 15 and 16 is adjusted by changing the power P₁ₐ and P_{1b} supplied to the corresponding heaters.

The optical circuit 2A has a third optical waveguide (optical waveguide 21) with the optical length L₂ₐ and a fourth optical waveguide (optical waveguide 22) with the optical length L_{2b}, which is shorter than the optical length L₂ₐ. One end of the optical waveguide 22 (FIG. 2, right) serves as the output port 52 of the optical filter 5A. The other end (FIG. 2, left) of the optical waveguide 22 is optically connected to the end (FIG. 2, right) of the optical waveguide 11. As a result, a signal light path is formed from the input port 51 to the output port 52. The optical waveguide 22 is provided with an optical coupler 23 and an optical coupler 24 in the enumerated order in the direction from the optical circuit 1A to the output port 52. The optical waveguide 21 is optically coupled to the optical waveguide 22 via the optical couplers 23 and 24. The optical waveguides 21 and 22 and the optical couplers 23 and 24 constitute the asymmetrical MZI optical circuit 2A.

The optical waveguides 21 and 22 are provided with heaters 25 and 26, respectively, control the second loss spectrum in a variable manner. The heaters 25 and 26 are used for adjusting the amount of phase-retardation with respect to light transmitted through the optical waveguide 21 and the optical waveguide 22, respectively, by adjusting the temperature of the optical waveguides 21 and 22. The temperature of the heaters 25 and 26 is adjusted by changing the power P₂ₐ and P_{2b} supplied to the corresponding heaters.

The loss control unit 3 is provided as a means for controlling the overall loss spectrum of the optical filter 5A. The loss control unit 3 controls the overall loss spectrum by shifting the loss spectra of both optical elements in the same direction with respect to wavelength or by shifting the loss spectra by the different absolute values with respect to the wavelength.

According to such a configuration and a control method therefor, the loss spectrum of the optical filter can be changed in various ways. As described later, by applying the optical filter to an optical amplifier, satisfactory gain flattening can be achieved with the optical amplifier. In the optical filter 5A shown in FIG. 2, the MZI optical circuits including the planar waveguide optical circuits are used as two optical elements, thus miniaturizing the optical filter 5A.

One method of controlling the overall loss spectrum of the optical filter is such that in a predetermined wavelength band (e.g., a signal light wavelength band in an optical transmission system) the overall loss spectrum is shifted with respect to wavelength while maintaining the shape of the overall loss spectrum. In this case, an optical filter can compensate a variation in the gain spectrum when the gain spectrum of the optical amplifier is shifted with respect to wavelength.

In another method, the overall loss spectrum is controlled in a manner such that the linearity of the loss spectrum is changed in a predetermined wavelength band. In this case, an optical filter is capable of compensating a variation in the gain spectrum when the linearity of the gain spectrum of the optical amplifier changes.

Variation in the gain spectrum of a Thulium-Doped Fiber Amplifier (TDFA) whose amplification wavelength band is an S-band wavelength band is more complicated due to the excited level structure of the TDFA as compared with an EDFA. In the application of a TDFA to a WDM transmission system, the gain spectrum of the TDFA varies due to a change in the number of channels of signal light transmitted in the WDM signal light, and a change in power of the signal light in each channel, etc. Many variations occur including a change in the gain gradient, a shift of the gain spectrum with respect to wavelength, and a change in the linearity of the gain spectrum. These variations in the gain spectrum may also occur in an optical amplifier using an optical fiber doped with a rare earth element other than thulium.

Even in such an optical fiber amplifier, such as a TDFA, in which complicated variations occur in the gain spectrum, the gain is satisfactorily flattened by using the above-described optical filter.

A detailed description of the specific configuration illustrated in FIGS. 1 and 2 and control methods therefor will be given here. A controlling method of an optical filter for shifting the overall loss spectrum with respect to wavelength while maintaining the shape of the overall loss spectrum in a predetermined wavelength band will now be described.

In order to shift the overall loss spectrum of the optical filter 5 with respect to wavelength while maintaining the shape of the overall loss spectrum, the loss spectrum of the first optical element and the loss spectrum of the second optical element are shifted in the same direction by the same amount. For example, in the example schematically shown in FIG. 1, the minimum wavelength λ₁ of the first loss spectrum is shifted to λ₁+Δλ, and the maximum wavelength λ₂ of the second loss spectrum is shifted to λ₂+Δλ. In this case, the overall loss spectrum is shifted with respect to wavelength by an amount Δλ while maintaining the spectrum's shape.

The case in which the center wavelength is shifted using the optical filter 5A will now be described. In general, the optical power transmission factor T of an asymmetrical MZI optical circuit including two optical couplers (directional couplers) and two optical waveguides that are provided between the optical couplers and that have different optical lengths is expressed by:

$$T = 1 - 2 C \cdot ( 1 - C ) \cdot \{ 1 + cos ( n \cdot \frac{2 π}{λ} \cdot Δ L + Δ φ ) \} \qquad ( 1 )$$

where C is the optical coupling factor of the directional couplers, n is the effective refractive index of the optical waveguides, ΔL is the difference in optical length between the optical waveguides (arm waveguides), and Δφ is the amount of phase shift due to a change in temperature of the heaters disposed in the optical waveguides.

When the phase shift of Δφ occurs due to a change in the heater temperature, the loss spectrum of the MZI optical circuit is shifted with respect to wavelength. From Eq. 1, the amount of shift Δλ of the loss spectrum due to the amount of phase shift Δφ caused by the heaters is derived as:

$$Δ λ ∝ \frac{{λ}_{0}^{2}}{2 n π \cdot Δ L} \cdot Δ φ \qquad ( 2 a )$$

where λ₀ is the center wavelength of the operating wavelength band of the MZI optical circuit.

In the planar waveguide optical circuit, the variation in power supplied to the heaters ΔP and the amount of phase shift Δφ are substantially in proportion to each other. In this case, Eq. 2a is represented as:

$$Δ λ ∝ \frac{{λ}_{0}^{2}}{2 n π \cdot Δ L} \cdot Δ P \qquad ( 2 b )$$

As is clear from Eq. 2b, the amount of shift Δλ of the center wavelength of the loss spectrum is in proportion to the amount of phase shift Δφ or the variation in the supplied power ΔP and in inverse proportion to the difference in optical length ΔL.

Even when the same amount of phase shift Δφ is caused, the amount of shift of the center wavelength Δλ is different depending on the difference in optical length ΔL. In the case of the optical filter 5A, therefore, in order to shift the center wavelength while substantially maintaining the shape of the overall loss spectrum, it is necessary to supply power to the heaters in accordance with the difference in optical length ΔL.

Specifically, in the optical filter 5A, the loss control unit 3 changes the overall loss spectrum under a condition in which the optical lengths L and the variations in the supplied power ΔP satisfy Eq. 3:

$$Δ {P}_{2 a} - Δ {P}_{2 b} = \frac{{L}_{2 a} - {L}_{2 b}}{{L}_{1 a} - {L}_{1 b}} ( Δ {P}_{1 a} - Δ {P}_{1 b} ) \qquad ( 3 )$$

where L₁ₐ, L_{1b}, L₂ₐ, and L_{2b} are the optical lengths of the first optical waveguide 11, the second optical waveguide 12, the third optical waveguide 21, and the fourth optical waveguide 22; and ΔP₁ₐ, ΔP_{1b}, ΔP₂ₐ, and ΔP_{2b} are variations in power supplied to the heaters (temperature adjusters) 15, 16, 25, and 26. Accordingly, the overall loss spectrum is shifted with respect to wavelength while maintaining the shape of the overall loss spectrum.

The above-described optical filter and control method therefor will now be described using a specific example. Each curve showing the loss spectrum described below is obtained by calculation. Power supplied to the heaters and variations in such power are expressed in units of mW.

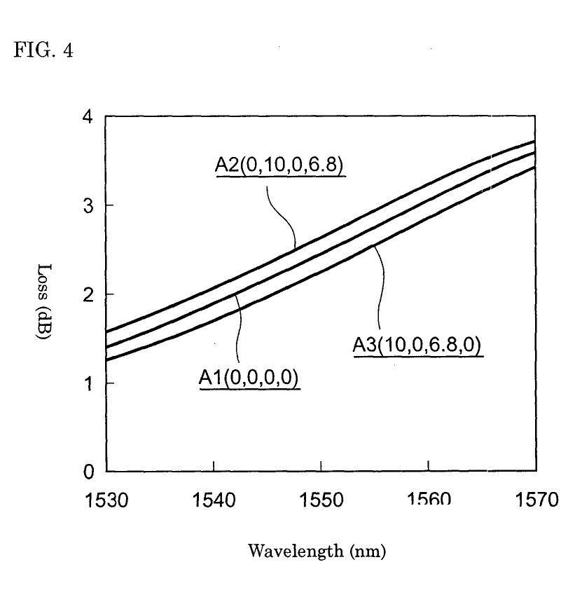

FIG. 4 is a graph showing examples of the overall loss spectrum of the optical filter 5A. The optical wavelength is plotted on the abscissa, and the loss (dB) on the ordinate. The curve A1 is a reference loss spectrum in FIG. 4. In FIG. 4 variations (ΔP₁ₐ, ΔP_{1b}, ΔP₂ₐ, and ΔP_{2b}) in power supplied to the heaters 15, 16, 25, and 26 relative to power supplied in the case of the reference loss spectrum are shown. The curve A2 shows a loss spectrum in the case where the variations (ΔP₁ₐ, ΔP_{1b}, ΔP₂ₐ, and ΔP_{2b}) are (0, 10, 0, and 6.8). The curve A3 shows a loss spectrum in the case where the variations (ΔP₁ₐ, ΔP_{1b}, ΔP₂ₐ, and ΔP_{2b}) are (10, 0, 6.8, and 0).

In order to produce a loss spectrum having good linearity, the difference, ΔL₁=L₁ₐ−L_{1b}, in optical length between the optical waveguides on the optical circuit 1A is set to be 13.36 μm, and the difference, ΔL₂=L₂ₐ−L_{2b}, in optical length between the optical waveguides on the optical circuit 2A is set to be 9.09 μm.

Referring to FIG. 4, the curve A2 shows a loss spectrum that is shifted toward the shorter wavelength side by 3.3 nm relative to the curve A1. The curve A3 shows a loss spectrum that is shifted toward the longer wavelength side by 3.3 nm relative to the curve A1. In such a case, the loss gradient of each loss spectrum is maintained within a range of 2.19 dB/40 nm to 2.22 dB/40 nm (0.05475 dB/nm to 0.05550 dB/nm). The variations (0, 10, 0, and 6.8) and (10, 0, 6.8, and 0) each satisfy Eq. 3. With this control method, the overall loss spectrum is shifted with respect to wavelength while the shape of the loss spectrum is maintained.

In the curves A1 to A3, the variation in loss gradient of the overall loss spectrum of the optical filter 5A is controlled so as to be greater than or equal to −0.1 dB/40 nm and less than or equal to 0.1 dB/40 nm (greater than or equal to −0.0025 dB/nm and less than or equal to 0.0025 dB/nm) with respect to a reference loss gradient (e.g., 2.205 dB/40 nm) within a predetermined wavelength band. Each loss spectrum is controlled to be shifted by a wavelength of 6 nm or greater (±3 nm or greater).

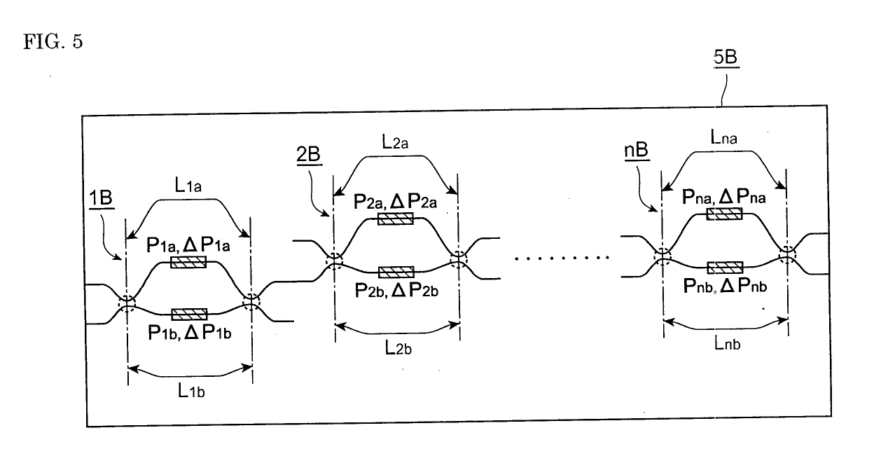

In general, the relation expressed with Eq. 3 is also applicable to an optical filter including three or more MZI optical circuits that are serially connected to one another. For example, referring to FIG. 5, in an optical filter 5B including first optical circuit 1B, second optical circuit 2B, . . . n-th optical circuit nB (n is an integer greater than or equal to 3), all of which are MZI optical circuits and connected together in series, the overall loss spectrum is changed under a condition satisfying Eq. 4:

$$Δ {P}_{ia} - Δ {P}_{ib} = \frac{{L}_{ia} - {L}_{ib}}{{L}_{1 a} - {L}_{1 b}} ( Δ {P}_{1 a} - Δ {P}_{1 b} ) \qquad ( 4 )$$

where i=2, 3, . . . , n. Thus, also in an optical filter including n MZI optical circuits, the center wavelength of the overall loss spectrum can be shifted while maintaining the shape of the overall loss spectrum.

A control method about an optical filter in which the linearity of the overall loss spectrum is changed within a predetermined wavelength band will now be described. In this case, the loss spectrum of each of the first optical element and the second loss spectrum is shifted by a greater amount than in the case shown in FIG. 4, and the loss spectrum of each of the first optical element and the second optical element is shifted by the same amount in the same direction.

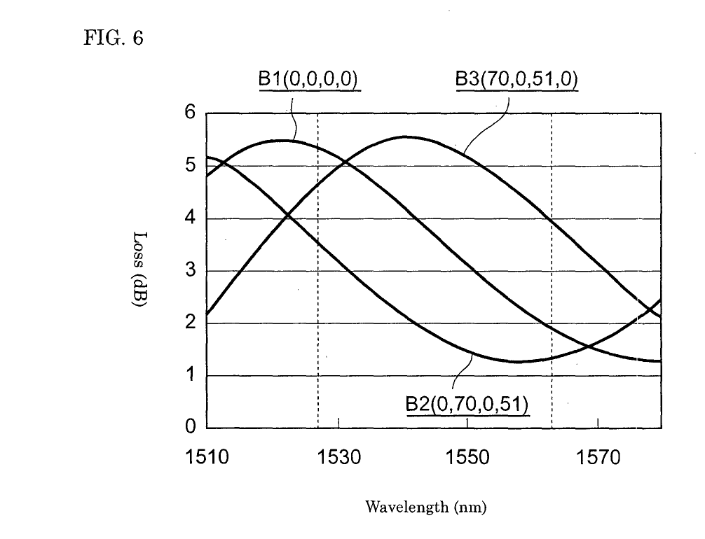

FIG. 6 is a graph showing examples of the loss spectrum of the optical filter 5A in the case of this control method. The abscissa shows the wavelength of light to which loss is provided, and the ordinate shows the loss (dB) provided to the light in the optical filter 5A as a whole. The curve B1 is a reference loss spectrum in FIG. 6. In FIG. 6 (ΔP₁ₐ, ΔP_{1b}, ΔP₂ₐ, and ΔP_{2b}) variations in the supplied power relative to the power supplied in the case of the reference loss spectrum are shown. The curve B2 shows a loss spectrum in the case where the variations (ΔP₁ₐ, ΔP_{1b}, ΔP₂ₐ, and ΔP_{2b}) are (0, 70, 0, and 51). The curve B3 shows a loss spectrum in the case where the variations (ΔP₁ₐ, ΔP_{1b}, ΔP₂ₐ, and ΔP_{2b}) are (70, 0, 51, and 0).

The linearity of the loss spectrum is evaluated on the basis of the sum Δ⁺+Δ⁻ (dB) where Δ⁺ (dB) is the maximum variation of loss in the positive direction relative to a line serving as a reference, and Δ⁻ (dB) is the maximum variation in the negative direction. The wavelength band in which the linearity is evaluated is set to a wavelength range of 1527 nm to 1563 nm as indicated by broken lines in FIG. 6. In FIG. 6 the linearity of the loss spectra corresponding to the curve B1, B2, and B3 are 0.39 dB, 1.14 dB, and 1.41 dB, respectively. Accordingly, it is understood that the linearity of the loss spectrum is changed with this control method. Such change is due to a sinusoidal waveform of the loss spectrum of MZI optical circuits that constitute the optical filter.

In the curves B1 to B3, the loss control unit 3 changes, in a predetermined wavelength band, the linearity of the overall loss spectrum within a range of less than or equal to 0.5 dB and greater than or equal to 1.4 dB. As a result, the linearity of the loss spectrum can be changed advantageously in a sufficiently wide range.

Besides the above-described control method, other methods can be used as a control method for the optical filter to change the linearity of the loss spectrum. Specifically, the linearity of the overall loss spectrum can be changed by a control method in which only one of the loss spectra of the first and second optical elements is shifted by a predetermined amount.

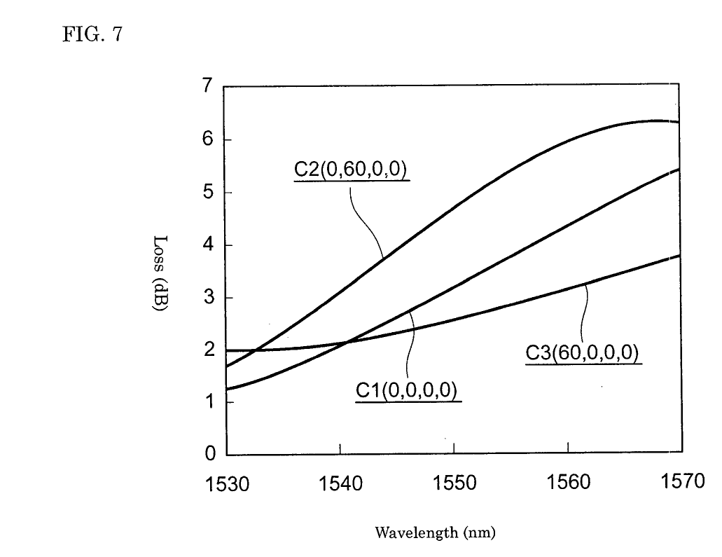

FIG. 7 is a graph showing examples of the loss spectrum of the optical filter 5A in the case of the control method in which only one of the loss spectra is shifted by a predetermined amount. The abscissa represents the optical wavelength, and the ordinate represents the loss (dB). The curve C1 is a reference loss spectrum in FIG. 7. In FIG. 7, variations (ΔP₁ₐ, ΔP_{1b}, ΔP₂ₐ, and ΔP_{2b}) in the supplied power relative to the power supplied in the case of the reference loss spectrum are shown. The curve C2 shows a loss spectrum in the case where the variations (ΔP₁ₐ, ΔP_{1b}, ΔP₂ₐ, and ΔP_{2b}) are (0, 60, 0, and 0). The curve C3 shows a loss spectrum in the case where the variations (ΔP₁ₐ, ΔP_{1b}, ΔP₂ₐ, and ΔP_{2b}) are (60, 0, 0, and 0).

Referring to FIG. 7, in the curve C1 the linearity of a loss spectrum is 0.28 dB and the loss gradient is 4.05 dB/40 nm. In the curve C2 the linearity of a loss spectrum is 1.22 dB and the loss gradient is 5.62 dB/40 nm. In the curve C3 the linearity of a loss spectrum is 0.45 dB and the loss gradient is 1.48 dB/40 nm. Accordingly, it is understood that also in the control method in which only one of the loss spectra of two optical elements is shifted, the linearity of the overall loss spectrum changes, as is the case with the control method in which both loss spectra are shifted.

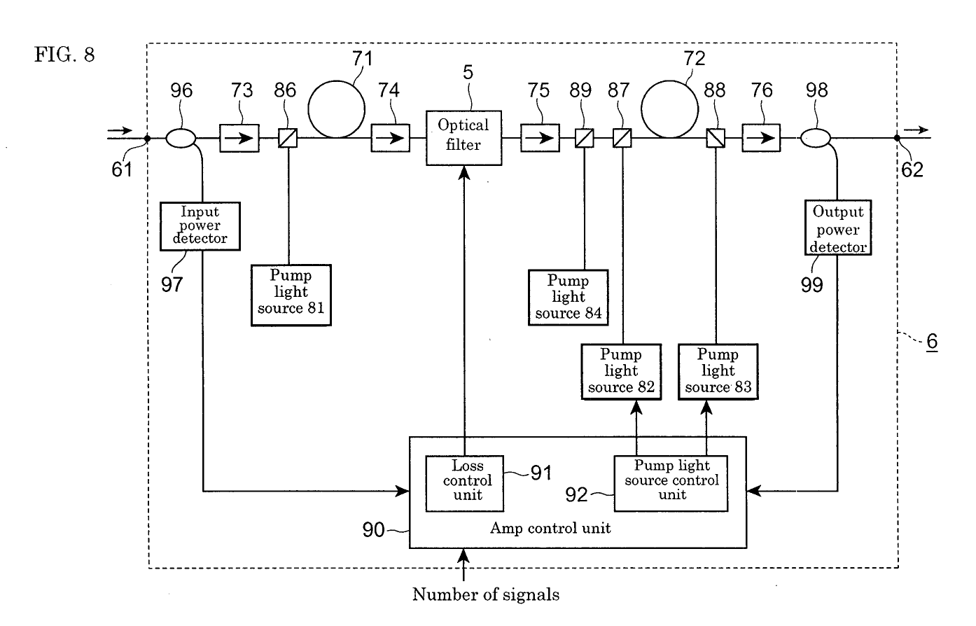

An optical amplifier according to the present invention will now be described. FIG. 8 is a block diagram showing an optical amplifier 6, which is an embodiment of an optical amplifier with the optical filter of the present invention. The optical amplifier 6 includes amplifying waveguides for amplifying signal light with pump light, pump light supplying units for supplying the pump light to the corresponding amplifying optical waveguides, and the optical filter 5.

The optical amplifier 6 shown in FIG. 8 is equipped with a first amplification fiber 71 at a previous stage and a second amplification fiber 72 at a subsequent stage, both of which function as amplifying optical waveguides constituting an optical transmission line in the optical amplifier 6. The amplification fibers 71 and 72, which are connected together in series, serve as an optical transmission line for propagating signal light input from an input port 61 to an output port 62 and for amplifying the propagated signal light in the optical amplifier 6. The optical filter 5 is disposed between the amplification fibers 71 and 72.

The direction in which the signal light propagates through the optical amplifier 6 is controlled by an optical isolator 73 between the input port 61 and the amplification fiber 71, an optical isolator 74 between the amplification fiber 71 and the optical filter 5, an optical isolator 75 between the optical filter 5 and the amplification fiber 72, and an optical isolator 76 between the amplification fiber 72 and the output port 62. The optical isolators 73, 74, 75, and 76 each pass light in the forward direction of the optical transmission line but do not pass light in the backward direction.

A pump light source 81 is disposed as a pump-light supplying unit for supplying pump light with a predetermined wavelength to the first amplification fiber 71 at the previous stage. The pump light source 81 is connected to the optical transmission line in the optical amplifier 6 via a WDM coupler 86 that is disposed between the optical isolator 73 and the amplification fiber 71 and that directs the pump light supplied by the pump light source 81 into the amplification fiber 71 so as to be multiplexed with signal light in the forward direction. The previous-stage portion of the optical amplifier 6 serves as an optical amplifier for forward directional pumping.

On the other hand, pump light sources 82, 83, and 84 are disposed as pump light supplying units for supplying pump light with a predetermined wavelength to the second amplification fiber 72 at the subsequent stage. The pump light source 82 is connected to the optical transmission line in the optical amplifier 6 by a WDM coupler 87 that is disposed between the optical isolator 75 and the amplification fiber 72 and that directs the pump light into the amplification fiber 72 so as to be combined in the forward direction with signal light. The pump light source 83 is connected to the optical transmission line in the optical amplifier 6 by a WDM coupler 88 that is disposed between the amplification fiber 72 and the optical isolator 76 and that directs the pump light supplied by the pump light source 83 into the amplification fiber 72 so as to be combined in the backward direction with signal light. The pump light source 84 is connected to the optical transmission line in the optical amplifier 6 by a WDM coupler 89 that is disposed between the optical isolator 75 and the WDM coupler 87 and that directs the pump light from the pump light source 84 to the amplification fiber 72 so as to be combined in the forward direction with signal light. The subsequent-stage portion of the optical amplifier 6 serves as an optical amplifier for bi-directional pumping.

A demultiplexer 96 that separates part of light input from the input port 61 is disposed between the input port 61 and the optical isolator 73. The portion of the input light separated by the demultiplexer 96 is detected by an input power detector 97 to monitor the power of the input light. A demultiplexer 98 that separates part of light to be output from the output port 62 is disposed between the output port 62 and the optical isolator 76. The portion of the output light separated by the demultiplexer 98 is detected by an output power detector 99 to monitor the power of the output light.

The result of monitoring the input light power by the input power detector 97 and the result of monitoring the output light power by the output power detector 99 are input to an amplification control unit 90. Also, information indicating the number of channels of the transmitted signal light is input from a monitoring system in the optical transmission system including the optical amplifier 6 to the amplification control unit 90. On the basis of the information including the input light power, the output light power, and the number of channels, the amplification control unit 90 controls the optical amplification of the optical amplifier 6.

In the optical amplifier 6, the amplification control unit 90 includes a loss control unit 91 and a pump light source control unit 92. Based on the above information, the loss control unit 91 controls the loss spectrum of the optical filter 5 via the loss control unit 3 of the optical filter 5. On the basis of the above information, the pump light source control unit 92 controls the power of the pump light supplied by the pump light sources 82 and 83 while maintaining the ratio.

As a result, the overall amplification gain of the optical amplifier 6 and the gain spectrum with respect to wavelength are controlled. In the above arrangement, the power of the pump light supplied by the pump light sources 81 and 84 is fixed.

The optical amplifier 6 shown in FIG. 8 may have, for example, the following configuration. Thulium-Doped Fibers (TDF) are used to serve as the amplifying optical waveguides (the amplification fibers 71 and 72). The wavelength of pump light supplied by the pump light sources 81 to 84 to the TDFs 71 and 72 is set as follows. Specifically, the wavelength of the pump light supplied by the pump light sources 81, 82, and 83 is set to 1.05 μm, and the wavelength of the pump light supplied by the pump light source 84 is set to 1.56 μm. When arranged as described above, the optical amplifier 6 serves as an optical amplifier in which a forward-directional-pumping TDFA at a previous stage and a bi-directional-pumping TDFA at a subsequent stage are connected together in series.

Thus, with the optical amplifier 6 to which the optical filter 5 is applied, it is possible to achieve sufficient flattening of gain by controlling the loss spectrum of the optical filter 5 in accordance with the gain spectra of the amplification fibers 71 and 72.

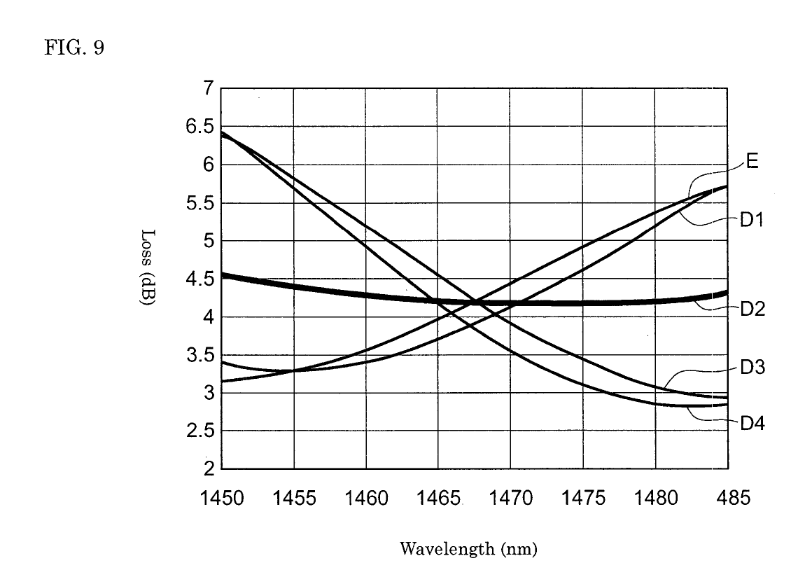

FIG. 9 is a graph showing examples of the loss spectrum of the optical filter 5 in the optical amplifier 6, which is a TDFA. The wavelength is plotted on the abscissa, and the overall loss (dB) of the optical filter 5 is plotted on the ordinate. It is assumed that the optical filter is the optical filter 5A.

The curve E is a loss spectrum of the optical filter 5A, which is designed to reduce the wavelength dependence of the power of the output signal of the optical amplifier 6. This loss spectrum serves as a reference loss spectrum in FIG. 9. The curves D1 to D4 show loss spectra of the optical filter 5 in a case where the wavelength dependence of the power of the output signal is maintained small when the number of channels of the signal light input to the optical amplifier 6 and the total power are changed to alter the gain spectrum of the optical amplifier 6.

Specifically, the curve D1 shows a loss spectrum when the number of channels is changed to 32 and the total power of the input signal light is changed to −10 dBm. The curve D2 shows a loss spectrum when the number of channels is changed to 32 and the total power of the input signal light is changed to −14 dBm. The curve D3 shows a loss spectrum when the number of channels is changed to 8 and the total power of the input signal light is changed to −20 dBm. The curve D4 shows a loss spectrum when the number of channels is changed to 2 and the total power of the input signal light is changed to −20 dBm.

Given the curves E and D1 to D4, Table I shows power P₁ₐ, P_{1b}, P₂ₐ, and P_{2b} supplied to the heaters 15, 16, 25, and 26; variations in the supplied power ΔP₁ₐ, ΔP_{1b}, ΔP₂ₐ, and ΔP_{2b} relative to the power in the case of reference loss spectrum shown by the curve E; and the differences of the variations, ΔP₁ₐ-ΔP_{1b} and ΔP₂ₐ-ΔP_{2b}. The amounts of phase shift Δφ₁ and Δφ₂ caused in the optical circuits 1A and 2A are in proportion to the respective differences in the variations ΔP₁ₐ-ΔP_{1b} and ΔP₂ₐ-ΔP_{2b}. In Table I, the supplied power is expressed in units of mW.

TABLE I

| | | D1 | D2 | D3 | D4 | E |
|---|---|---|---|---|---|---|
| Heater 15 | P₁ₐ | 109.4 | 23.4 | 319.5 | 361.2 | 59.9 |
| | ΔP₁ₐ | 49.5 | −36.5 | 259.6 | 301.3 | 0 |
| Heater 16 | P_{1b} | 148.7 | 148.7 | 149.2 | 224.7 | 148.7 |
| | ΔP_{1b} | 0 | 0 | 0.5 | 76 | 0 |
| | ΔP₁ₐ − ΔP_{1b} | 49.5 | −36.5 | 259.1 | 225.3 | 0 |
| Heater 25 | P₂ₐ | 28.8 | 28.8 | 28.8 | 28.8 | 28.8 |
| | ΔP₂ₐ | 0 | 0 | 0 | 0 | 0 |
| Heater 26 | P_{2b} | 158.2 | 133.1 | 73.9 | 71.8 | 175.7 |
| | ΔP_{2b} | −17.5 | −42.6 | −101.8 | −103.9 | 0 |
| | ΔP₂ₐ − ΔP_{2b} | 17.5 | 42.6 | 101.8 | 103.9 | 0 |

Of the control conditions of the optical filter shown in FIG. 9 and Table I, the condition in which the curve E is changed to the curves D1, D2, and D3 satisfies the condition for controlling the two optical circuits so that their loss spectra are shifted in the same direction; and the condition in which the curve E is changed to the curves D2, D3, and D4 satisfies the condition for controlling the two optical circuits so that their loss spectra are shifted by the different absolute value with respect to the wavelength.

With the arrangement of the above-described optical filter and the control method therefor, the loss spectrum of the optical filter is changed in various ways in accordance with variations in the gain spectrum of the optical amplifier. For example, when the total power of the input signal light is −20 dBm and the number of channels is 2, the power of the output signal light becomes flatter by using the curve D4, which is less linear than the curve D3.

The optical filter according to the present invention and the optical amplifier using the same are not limited to the above-described embodiments, and various modifications are possible. For example, the optical filter is not limited to the two-stage configuration shown in FIGS. 1 and 2: it may have a configuration with three or more stages, as shown in FIG. 5. The optical elements used in the optical filter are not limited to the MZI optical circuits shown in FIG. 2: they may be other kinds of optical elements (other than the MZI optical circuits) with sinusoidal loss spectra.

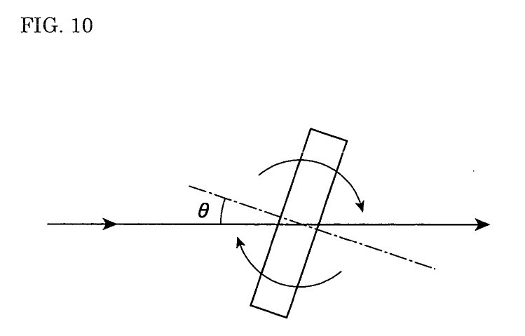

A Fabry-Perot etalon shown in FIG. 10 may be used as an optical element of the optical filter. A Fabry-Perot etalon includes a glass film with both surfaces covered with a reflective coating with a predetermined reflection factor. Such a Fabry-Perot etalon is tilted with respect to the optical axis to achieve a sinusoidal loss spectrum that can be shifted with respect to wavelength. Specifically, a transmission spectrum achieved by the Fabry-Perot etalon is expressed by the following function T(λ):

$$T ( λ ) = \frac{1}{1 + \frac{2 R}{{( 1 - R )}^{2}} ( 1 - cos ( \frac{4 π nd cos θ}{λ} ) )} \qquad ( 5 )$$

where R is the reflection factor of the reflective coating on both surfaces of the Fabry-Perot etalon, n is the refractive index of the Fabry-Perot etalon, d is the thickness of the Fabry-Perot etalon, and θ is the angle of tilt.

A sinusoidal loss spectrum that can be shifted with respect to wavelength may be achieved by using a so-called lattice type optical circuit including a polarization beam splitter, a birefringence plate in one of two separated optical paths, and wedge-shaped elements at a few stages (e.g., see M. Fukutoku et. al, OAA 1996, Tech. Dig., FA4 (1996)). In the case of the lattice type optical circuit, the amplitude of the loss can also be changed. Similar advantages can be achieved by replacing the birefringence plate with liquid crystal in the lattice type optical circuit.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

The entire disclosure of Japanese Patent Application No. 2002-262089, filed on Sep. 16, 2002, including specification, claims, drawings, and summary are incorporated herein by reference in its entirety.

What is claimed is:

1. An optical filter comprising:
a first optical element with a first loss spectrum;
a second optical element with a second loss spectrum, the second optical element being scrially connected to the first optical element; and
a control means for controlling the overall loss spectrum by shifting the first loss spectrum and the second loss spectrum in the same direction with respect to wavelength.

2. An optical filter according to claim 1, wherein the control means shifts the first loss spectrum and the second loss spectrum by the same amount with respect to wavelength.

3. An optical filter according to claim 2, wherein the control means shifts the overall loss spectrum with respect to wavelength while maintaining the shape of the overall loss spectrum within a predetermined wavelength band.

4. An optical filter according to claim 1, wherein the control means shifts the overall loss spectrum by an amount of 6 nm or greater while maintaining, within a predetermined wavelength band, a change in a loss gradient of the overall loss spectrum greater than or equal to −0.0025 dB/nm and less than or equal to 0.0025 dB/nm.

5. An optical filter according to claim 1, wherein the control means changes the linearity of the overall loss spectrum within a predetermined wavelength band.

6. An optical filter according to claim 1, wherein the control means changes the linearity of the overall loss spectrum within a range less than or equal to 0.5 dB and greater than or equal to 1.4 dB in a predetermined wavelength band.

7. An optical filter according to claim 1, wherein the first optical element includes a first optical waveguide and a second optical waveguide, the second optical waveguide having an optical length shorter than that of the first optical waveguide, the second optical waveguide being optically coupled to the first optical waveguide via at least two optical couplers to form, in conjunction with the first optical waveguide, a Mach-Zehnder interferometer, and
wherein the second optical element includes a third optical waveguide and a fourth optical waveguide, the fourth optical waveguide having an optical length shorter than that of the third optical waveguide, the fourth optical wave guide being optically coupled to the third optical waveguide via at least two optical couplers to form, in conjunction with the third optical waveguide, a Mach-Zehnder interferometer.

8. An optical filter according to claim 7, wherein the control means controls the overall loss spectrum under a condition satisfying:
$$Δ {P}_{2 a} - Δ {P}_{2 b} = \frac{{L}_{2 a} - {L}_{2 b}}{{L}_{1 a} - {L}_{1 b}} ( Δ {P}_{1 a} - Δ {P}_{1 b} )$$
where L₁ₐ, L_{1b}, L₂ₐ, and L_{2b} are the optical lengths of the first, second, third, and fourth optical waveguides, and ΔP₁ₐ, ΔP_{1b}, ΔP₂ₐ, and ΔP_{2b} are variations in power supplied to temperature adjusters disposed in the first, second, third, and fourth optical waveguides.

9. An optical amplifier comprising:
an amplifying optical waveguide for amplifying signal light with pump light;
a pump light supplying means for supplying the pump light to the amplifying optical waveguide; and
an optical filter defined in claim 1, the optical filter being connected to the amplifying optical waveguide in series.

10. An optical amplifier according to claim 9, wherein the amplifying optical waveguide is doped with thulium.

11. An optical filter comprising:
a first optical element with a first loss spectrum;
a second optical element with a second loss spectrum, the second optical element being serially connected to the first optical element; and
a control means for controlling the overall loss spectrum by shifting the first loss spectrum or the second loss spectrum by different absolute values with respect to wavelength.

12. An optical filter according to claim 11, wherein only one of the first loss spectrum and the second loss spectrum is shifted.

13. An optical filter according to claim 11, wherein the first optical element includes a first optical waveguide and a second optical waveguide, the second optical waveguide having an optical length shorter than that of the first optical waveguide, the second optical waveguide being optically coupled to the first optical waveguide via at least two optical couplers to form, in conjunction with the first optical waveguide, a Mach-Zehnder interferometer, and
wherein the second optical element includes a third optical waveguide and a fourth optical waveguide, the fourth optical waveguide having an optical length shorter than that of the third optical waveguide, the fourth optical waveguide being optically coupled to the third optical waveguide via at least two optical couplers to form, in conjunction with the third optical waveguide, a Mach-Zehnder interferometer.

14. An optical amplifier comprising:
an amplifying optical waveguide for amplifying signal light with pump light;
pump light supplying means for supplying the pump light to the amplifying optical waveguide; and
an optical filter defined claim 11, the optical filter being serially connected to the amplifying optical waveguide.

15. An optical amplifier according to claim 14, wherein the amplifying optical waveguide is doped with thulium.
